(19) United States
(12) Patent Application Publication
(10) Pub. No.: US 2007/0203789 A1
(43) Pub. Date: Aug. 30, 2007

(54) DESIGNING HYPERLINK STRUCTURES

(75) Inventors: Kamal Jain, Bellevue, WA (US); Christian Herwarth Borgs, Seattle, WA (US); Gary W. Flake, Bellevue, WA (US); Jennifer Tour Chayes, Seattle, WA (US); Mohammad Mahdian, Bellevue, WA (US); Nicole S. Immorlica, Seattle, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/426,500

(22) Filed: Jun. 26, 2006

Related U.S. Application Data
(60) Provisional application No. 60/776,978, filed on Feb. 27, 2006.

(51) Int. Cl. G06Q 30/00

(52) U.S. Cl. 705/14

(57) ABSTRACT

The subject disclosure pertains to an architecture that maximizes revenue of a website. In particular, the hyperlink structure between the web pages of a website can be designed to maximize the revenue generated from traffic on the website. That is, the set of hyperlinks placed on web pages is optimized by selecting hyperlinks that are most likely to generate the optimal revenue. Hyperlinks can be placed on web pages according to various criteria or variable values in order to create an optimized web page that generates the maximum revenue for the website.

### RELATED APPLICATIONS

This application claims the benefit of Provisional U.S. Patent Application Ser. No. 60/776,978, filed Feb. 27, 2006, entitled “DESIGNING HYPERLINK STRUCTURES”, the entirety of which is incorporated herein by reference.

### BACKGROUND

Companies can own thousands (and in some cases millions) of related web pages in connection with advertisement of goods and/or services. Web pages that belong to various departments or divisions within a given company can potentially offer different products or services, but these web pages are generally part of a larger web page structure that constitutes the website, which belongs to the company as a whole. As a result, the individual web pages are linked together using hyperlinks that also must be generated to meet both the needs of the organization and those of the individual departments or divisions.

One problem that arises when attempting to create a hyperlink structure between large numbers of pages is optimization. Hyperlinks on a web page allow a user to navigate to different pages within the web site in order to locate content of interest. Accordingly, it is beneficial for the owner of a website to select hyperlinks displayed on the page such that a user would find them useful whilst generating the maximum revenue possible for the owner of the website. Guessing and subsequently selecting the hyperlinks that are most likely to be followed in order to maximize revenue can be difficult and non-optimal if performed naively, yet that is the approach by which many sites proceed.

### SUMMARY

The claimed subject matter generally relates to optimizing website design through automated selection and placement of hyperlinks associated therewith to maximize revenue generation for the website. More specifically, described herein are systems/methods that are employed to maximize revenue generated from a web site based on hyperlinks that are placed on respective web pages either through revenue generated from advertisements or sale of products listed on the web pages. Conventional systems rely on manually updating hyperlinks associated with a web page in accordance with current contemplations as to what particular hyperlinks would be most beneficial, which is a time-consuming and imperfect task. As a result, such conventional systems are subject to significant opportunity costs associated with loss of potential revenue (and lost man-hours).

Typically, web pages generate varying amounts of revenue, for example, through advertisements and/or product sales. Additionally, web pages often display hyperlinks to other pages on the web site. Each possible hyperlink has a transition probability representing the probability that a surfer clicks on the hyperlink conditional on the other links on the page. A web designer should select a sub-graph which maximizes expected revenue of a random walk. The stated problem has a seemingly complex nature, but in a very general setting, this difficulty can be formulated as a problem of computing a fixed point of a function, which allows for approximating an optimal solution to within an arbitrary degree of precision in polynomial time. The problem can also be formulated as a mathematical program which is reduced to a linear program. The linear program can be rounded such that a subset of variables of the mathematical program (representing link existence) is integral—this solution then describes the optimal web site design.

To aid in maximizing revenue for a website, a graph optimization system is provided that can be integrated within a revenue maximization system or communicatively coupled thereto as a non-native tool. The graph optimization system can receive a representative graph that comprises nodes and edges corresponding to web pages and hyperlinks, respectively, and can compute expected revenue of random walks through the graph. The graph optimization component can further select a sub-graph through the graph that yields maximum expected revenue. In accordance therewith, once a revenue maximizing sub-graph has been selected, the sub-graph can be provided to the revenue maximization system (e.g., as data that is representative of a graph) for website design.

A computation component can compute expected revenue of a random walk within a graph to aid in determining sub-graph(s) that are expected to result in maximum revenue for the website. This can be accomplished by iterating through the graph and adding edges until the random walk reaches a fixed length. By computing the expected revenue of a random walk that originates at each node of the graph, the computation component develops a sub-graph that can be used to determine the maximum expected revenue sub-graph within the original graph. Moreover, a selection component can be employed to determine a maximum expected revenue of a random walk originating from each node of the graph by extending the walk received from the computation component one additional edge such that the new random walk maximizes the expected revenue from a specified node. Additionally, a validation component can be utilized to constrain variables associated with each node and edge of the graph (e.g. the expected revenue of an edge). By constraining the variables while attempting to maximize the expected revenue of the walk through the graph, the sub-graph yielding the maximum expected revenue can be identified.

To the accomplishment of the foregoing and related ends, certain illustrative aspects are described herein in connection with the following description and the annexed drawings. These aspects are indicative of various ways in which the claimed subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 illustrates a block diagram of an exemplary revenue maximization system.

FIG. 2 illustrates a block diagram of a computation component that includes an aggregation component, wherein the computation component and the aggregation component are utilized in connection with selectively placing hyperlinks within web pages.

FIG. 3 illustrates a block diagram of a selection component that employs a comparison component to optimize revenue generation.

FIG. 4 illustrates a block diagram of a selection component that includes a verification component.

FIG. 5 is a representative flow diagram illustrating a revenue maximization method that computes maximum revenue sub-graphs iteratively.

FIG. 6 is a representative flow diagram illustrating a revenue maximization method utilizing constraints.

FIG. 7 is a representative flow diagram relating to computing revenue over a random walk.

FIG. 8 is a representative flow diagram of a method for determining maximum expected revenue of a random walk through a graph

FIG. 9 is a schematic block diagram illustrating a suitable operating environment.

FIG. 10 is a schematic block diagram of a sample-computing environment.

### DETAILED DESCRIPTION

The various aspects of the claimed subject matter are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

As used in this application, the terms “component” and “system” and the like are intended to refer to a computer-related entity, either hardware, a combination of hardware and software, software, or software in execution. For example, a component may be, but is not limited to being, a process running on a processor, a processor, an object, an instance, an executable, a thread of execution, a program and/or a computer. By way of illustration, both an application running on a computer and the computer can be a component. One or more components may reside within a process and/or thread of execution and a component may be localized on one computer and/or distributed between two or more computers. The word “exemplary” is used herein to mean serving as an example, instance, or illustration. Any aspect or design described herein as “exemplary” is not necessarily to be construed as preferred or advantageous over the other aspects or designs.

Furthermore, all or portions of the subject innovation may be implemented as a method, apparatus, or article of manufacture using standard programming and/or engineering techniques to produce software, firmware, hardware, or any combination thereof to control a computer to implement the disclosed innovation. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

It should also be noted and appreciated that although various aspects of the claimed subject matter are described with respect to revenue generation through an optimization of the hyperlink structure to other web pages within the same web site, the claimed subject matter is not limited thereto. Disclosed aspects can also be employed with other types of systems that have a structure that can be expressed as a graph of nodes and edges.

Further yet, various aspects are described solely with respect to revenue generation through web pages and hyperlinks thereto for purposes of brevity. However, it should be noted that other revenue generation schemes are also contemplated and are to be considered within the scope of claimed subject matter including but not limited to revenue generated through the placement of advertisements on web pages.

The claimed subject matter generally addresses a difficulty of hyperlink placement on web pages within the larger structure of an entire website, and can eliminate the onerous and inefficient task of manually selecting and placing said hyperlinks. Moreover, when selecting hyperlinks to place on a website/web page, one does not often consider that different hyperlinks can have different potential for revenue generation. By modeling these aspects with an approximation algorithm or linear program, an efficient solution that uses the disparate revenue values associated with each web page and hyperlink to make determinations regarding the placement of hyperlinks can be achieved.

Prior to discussing various high-level embodiments of the invention in connection with the accompanying figures, a discussion of a model, algorithms, corresponding theorems and techniques will be described in order to provide context for better appreciating and understanding the invention.

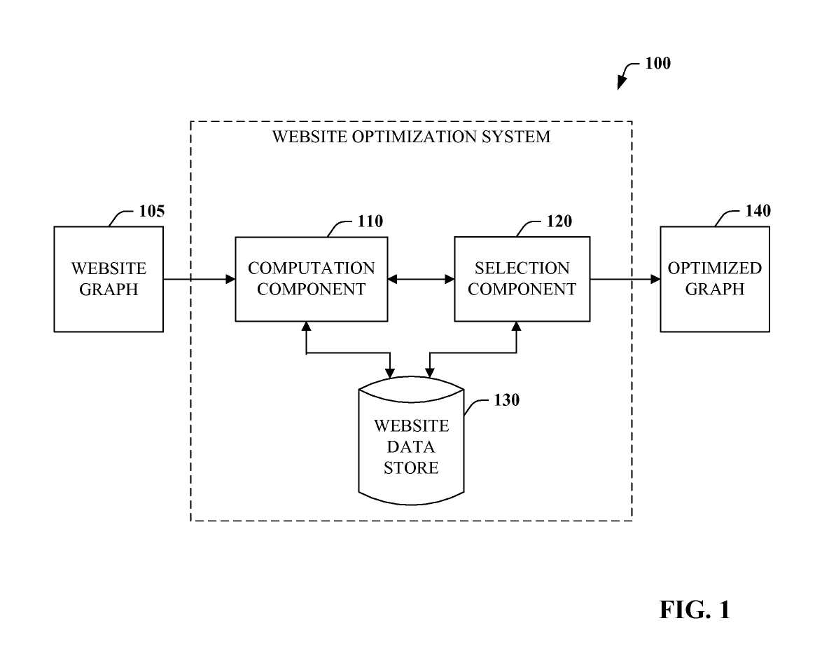

Referring initially to FIG. 1, a system 100 that facilitates website optimization is illustrated. The system 100 can include a computation component 110 that receives a graph 105. Graph 105 can be a model or representation of a website with many individual web pages (e.g., nodes) and many hyperlinks (e.g., edges) from one web page to another web page. For example, graph 105 can represent a directed graph: G=(N, E), wherein each node iεN can be a web page. The number of nodes is denoted by n=|N|, and an edge ij exists from node i to node j if page i links to page j. Typically, it is assumed that the graph (e.g., graph 105) contains no self-loop, e.g., a web page does not contain a hyperlink to itself. It is to be appreciated that the terms “web page” or “page” is substantially interchangeable with the term “node” when referring to graph 105, which is a model of the entire website. Similarly, the term “hyperlink” is used interchangeably with the term “edge” when referring to graph 105.

The computation component 110 can store data related to the website and its organization in the website data store 130 that is communicatively coupled to the computation component 110. The system 100 can also include a selection component 120 that is communicatively coupled to the computation component 110 and the website data store 130, wherein the selection component 120 can identify an optimized graph 140. The optimized graph 140 can also be a directed graph and is typically representative of a website design that will facilitate maximizing revenue. For example, the revenue generated by a website can be maximized by optimizing the hyperlink structure between individual web pages. The optimized graph 140 can denote the revenue maximizing sub-graph within the graph 105.

Revenue generation though a website can be accomplished through product purchases or advertisements, but both have a quantifiable expected revenue value that is associated with the web page. Such values related to the graph 105, expressed as variables, can be generated by the computation component 110 or from, e.g., empirical data and input to the data store 130. The expected revenue values can be retrieved from the website data store 130 by the computation component 110 or the selection component 120. These variables can include a probability p_{ij,S} corresponding to whether a particular edge of the graph 105 exists and will likely be followed by the user, a variable t corresponding to the number of steps taken for each random walk, and a revenue variable rᵢⱼ that is associated with that particular edge. More specifically, the revenue variable can represent the expected revenue generated when a user browsing the website visits page j via a hyperlink contained on page i.

By computing the expected revenue over random walks through the graph 105, the sub-graph that is expected to maximize the revenue of the website can be identified. The selection component 120 can receive or retrieve data corresponding to random walk(s) through the graph 105 from the computation component 110, including the node from which the random walk originates and the revenue generated along that random walk. Since each node within the graph 105 represents a web page, and selection component 120 can successively iterate through the potential maximum length random walks from a given node and selects the sub-graph composed of the random walks that yields the maximum revenue according to variables associated with the graph 105. Based on this and other data, including any data retrieved from the website data store 130, the selection component 120 can maximize the revenue of a sub-graph within the graph 105 and output this as optimized graph 140.

Thus, the system 100 can receive a directed graph 105 corresponding to a website, and analyzes nodes and edges associated with the directed graph 105, where the nodes represent web pages and the edges represent links of respective web pages with quantifiable expected revenue values. The analysis can involve identifying revenue maximizing random walks associated with the respective nodes and edges. Once revenue maximizing walks are identified, a sub-graph (e.g., optimized directed graph 140) is generated that comprises the revenue maximizing random walks over the directed graph 105.

In accordance with one aspect of the claimed subject matter, a random walk through the graph 105 can represent to a web surfer traversing hyperlinks on the website. For each page j, there is a probability pⱼ that the surfer starts surfing from page j. For each page i, set S⊂N, {i} of other pages, and page jεS, there is a probability p_{ij,S} that a surfer on page i follows a hyperlink to page j, assuming that the set of pages linked from page i is S. It is assumed that for all i and S⊂N, {i}, Σ_{jεS}p_{ij,S}≦1−δ for some positive constant δ>0, e.g., in each step there is a non-zero probability that the surfer exits the web site. This is a reasonable assumption, in connection with the analysis of the iterative algorithm described infra in connection with selection component 120.

An expected revenue for a random walk on the web site can be defined by assigning a revenue rⱼ to each page j (this would correspond to the expected revenue that a surfer visiting page j would generate for the web site owner, perhaps from the advertisement on the page, by buying a product on the page, etc.). Thus, the expected revenue of a random walk can be defined as the sum, over all j, of rⱼ times the expected number of times that the random walk visits j.

It should be appreciated that in one aspect, revenues are assigned to edges instead of vertices. For example, for each hyperlink ij, there a value rᵢⱼ representing the expected revenue generated for page j by a web surfer who has followed link ij. The total revenue is defined as the sum, over all edges ij in the graph 105, of rᵢⱼ times the expected number of times the random walk traverses the edge ij. It should be noted that utilizing edges rather than vertices can yield a strictly stronger model, since setting rᵢⱼ=rⱼ for all i would be equivalent to assigning revenues to vertices (when adding the value Σⱼpⱼrⱼ for the revenue of the first page the surfer visits). However, assigning revenues to edges enables modeling situations where the conversion rate of a user depends on the web page she is coming from, and can be useful in modeling content-related websites.

It should also be noted that total revenue can be defined by multiplying rᵢⱼ's by the expected number of times the random walk takes the corresponding edge, as opposed to the probability that the random walk takes a particular edge. This means that if the random walk visits a vertex twice, it will benefit the web site owner twice. This is a realistic assumption in many situations, e.g., where the revenue is generated from “per-impression” advertisements. The above model for representing a website as a directed graph 105 is can allow for situations where the probability that a surfer clicks on a link to page j placed on page i depends not only on i and j, but also on the set of other links on the page i. In economic terminology, this means that the graph 105 can model externalities among the links placed on a page i.

An interesting and important special case is the case of no externalities. In accordance with another aspect of the claimed subject matter, each page has limited real-estate in which it can display links, and so each node i can have out-degree at most kᵢ (a parameter). For each i,jεN, there is a probability pᵢⱼ that a surfer on page i follows a hyperlink to page j, if such a link exists. It is assumed that for all i, and for any set S of kᵢ pages, the sum Σ_{jεS}pᵢⱼ≦1δ, so these probabilities define a random walk with exit probability at least δ in each step. In this model there is still an externality among the links, since placing each link further limits the number of other links that can be placed on the page. However, this is the only form of externality allowed in this case.

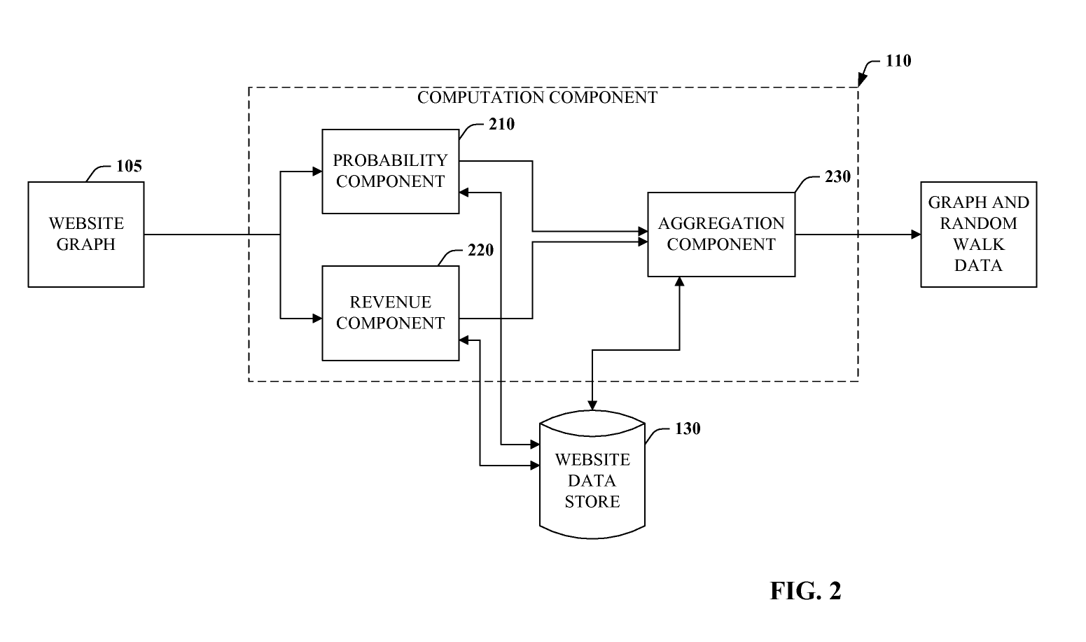

Turning now to FIG. 2, the computation component 110 is depicted in more detail. In particular, the computation component 110 can include a probability component 210 that determines expected probability p_{ij,S} that a user will follow a hyperlink from page i to page j. The computation component 110 can also include a revenue component 220 that assigns an expected revenue value rᵢⱼ corresponding to the revenue generated by a web user following that link from node i to node j through a hyperlink. The computation component 110 can further include an aggregation component 230 that computes expected revenue along a random walk originating from node i through the graph 105. Furthermore, because there likelihood that a user will click a given link can change based on the link's location within the web page, the computation component 110 can compensate for such disparities by computing the maximum revenue over a sequence of links rather than a set of links. By providing order to the links, rather than simply looking at the composite set, the computation component 110 can determine whether different orders of the same links produces disparate expected revenues, which can facilitate identification of a maximum expected revenue value. As a result, the computation component 110 can determine the links as well as the placement of such links within the web page that yield a maximum revenue value.

In another aspect of the claimed subject matter, the expected revenue value rᵢⱼ could be replaced with a cost cᵢⱼ associated with an edge of the graph 105. In accordance therewith, the system could employ a graph (e.g., graph 105), that is, for example, associated with an advertising system that utilizes a “per click” or “per view” cost structure. As such, the cost of traversing a link between two web pages would incur some cost rather than generating revenue. Adjusting the maximization objective to represent the cost of edges rather than the generated revenue appropriately adjusts the system for this alternate embodiment.

Still referring to FIG. 2, components 210, 220, and 230 are all connectively coupled to website data store 130, such that the data associated with a web site can be stored or updated. The revenue along a random walk can be aggregated in steps that continually extend the length of the walk through the graph 105 until it is of length T. For instance, if i and j are nodes in the graph 105, N is the set of nodes in the graph 105, and S is a subset of N, such that all the nodes jεS if i contains a hyperlink to page j, a revenue value rᵢⱼ represents the expected revenue value from a web user following a hyperlink from page i to page j, and t represents the number of steps of the random walk, then the sum of the revenue values multiplied by the probability p_{ij,S} (which represents the probability of the edge from page i to page j for some page j, and the summation of the revenue over the nodes in the set S) yields the possible random walks of length T that originate from node i.

Expressed alternatively: For t:=1 to T do for every i, let
Rᵢ^{t}:=max_{S⊂N}{Σ_{jεS}p_{ij,S}(Rⱼ^{t-1}+rᵢⱼ)}.
The aggregation component 230 can compute the revenue along random walks of length T for each node i of the graph 105 through the other nodes in S. After the set of random walks from node i has been computed, the sub-graph composed of the random walks with the maximum expected revenue can be identified and transmitted to the selection component 120. It should be noted that there is the possibility that certain hyperlinks should might be constrained to always or never be contained on a website, regardless of the expected revenue associated with said hyperlinks. By adjusting the probability of such hyperlinks, the optimized sub-graph through the graph 105 can always or never include certain hyperlinks based on preferences and adjustments to the system. For example, a given website might always contain a link to another website or always exclude links to another website based on content or some other consideration. By fixing the transitional probability of the link between web pages represented by nodes within the graph 105, certain links will always (e.g., setting the probability to 1) or never (e.g., setting the probability to 0) be included in the graph 105. Because of the so-called PageRank system for sorting web page search results, which attempts to ascertain the probability of an individual web page in the stationary distribution over a random walk on the web, it is contemplated that a fixed link for each of the web pages within a larger website should be the web page with the highest entrance probability.

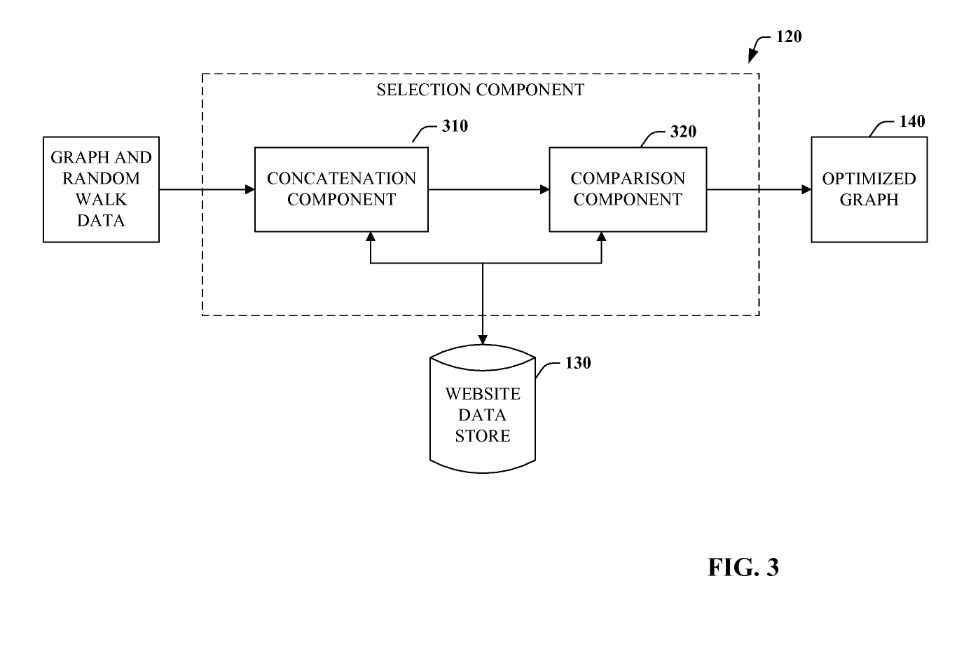

With reference now to FIG. 3, the selection component 120 is depicted in greater detail. The selection component 120 can include a concatenation component 310 that extends the length of a random walk received from the computation component 110 in order to maximize the revenue of the random walk. By computing revenue of an existing random walk of length T and adding the expected revenue of an additional edge that has an associated probability that is greater than zero, the revenue generated over a random walk starting from a specified node can increase. Furthermore, selection component 120 can include a comparison component 320 that selects the random walk through the graph 105 originating from node i that generates the maximum revenue. Both components are coupled to data store 130, which allows for website data stored therein to be used by the concatenation component 310 and comparison component 320. The comparison component 320 can examine extended random walks generated by the concatenation component 310. From the associated revenue values, and after examining the possible random walks that are now of length T+1, the comparison component 320 can select the random walk from a given node that generates the maximum revenue.

For instance, for every i, it can be assumed that Sᵢ:=argmax_{S⊂N}{Σ_{jεS}p_{ij,S}(Rⱼ^{T}+rᵢⱼ)}. By iterating through the possible nodes, j, the comparison component 320 can generate the set of possible random walks from i of length T+1, and the argmax function selects the maximal expected revenue random walk from that set. Thus the revenue generated along the random walk is maximal for all jεS, and the comparison component 320 selects the maximum revenue generating walk originating from i. It should be further noted that this procedure for determining the random walk that generates the maximum expected revenue for each node i can be repeated for each i, such that the set of such random walks is computed for the graph 105. Such data can be stored in the website data store 130 and output in the form of optimized sub-graph 140 that maximizes revenue within the original graph 105.

In accordance with one aspect of the claimed subject matter, an efficient iterative algorithm to compute the revenue-maximizing hyper-link structure can be employed. The iterative algorithm can begin with the following lemma, which computes the revenue of a given graph (e.g., graph 105): Let G(N,E) be a directed graph and δ⁺(i) denote the set of vertices that have an edge from i in G. Also, let Rᵢ denote the expected revenue of a random walk in G that starts from node i. Then {Rᵢ}_{iεN} is the unique solution of the system of equations:

$$∀ i : {R}_{i} = {\sum }_{j ∈ {δ}^{+} ( i )} {p}_{ij , S} ( {R}_{j} + {r}_{ij} ) . \qquad ( 1 )$$

It is readily apparent that R is a solution of this system of equations. Therefore, in terms of proof for the solution, it is enough to show that this solution is unique. This follows from the fact that the matrix of coefficients of this system has −1 along the main diagonal, and on each row, the sum of the off-diagonal entries is Σ_{jεδ}_{⁺}₍ᵢ₎p_{ij,S}≦1−δ<1. This implies that the matrix is non-singular, and therefore Equations (1) each has a unique solution. Moreover, it can be shown that the optimal solution corresponds to the fixed point of a function defined below.

Given the values of p_{ij,S}'s and r_{i,j}'s, we define a function φ:Rⁿ [symbol] Rⁿ as follows: for a vector R=(R₁,R₂ . . . Rₙ), φ(R) is a vector whose i'th component is φᵢ(R)=max_{S⊂N}{Σ_{jεS}p_{ij,S}(Rⱼ+rᵢⱼ)}.

In accordance with another aspect, a second lemma can be provided. The following lemma assumes that the starting probabilities pᵢ are all non-zero. It will later be seen that there is a graph (e.g., graph 140) which is optimal with respect to any set of starting probabilities, and therefore this assumption serves only to remove degenerate cases.

Assume for each i, pᵢ>0. Let G* be the revenue-maximizing graph 140, and Rᵢ* be the expected revenue of a random walk in G* that starts from node i. Then R* is the unique fixed point of the function φ. Proof for the second lemma is based on a theorem which shows that every map that is contraction of a metric space has a unique fixed point and is shown below. Therefore, by showing that f is a contraction under the l_{∞} norm, the proof is supplied. However, first the definition of an increasing function and a contraction are given:

Definition of an increasing function: For two vectors x,x′εRⁿ, we say x≦x′ if xᵢ≦x′ᵢ for all i. We say that a function f:Rⁿ [symbol] Rⁿ is increasing if for every x,x′εRⁿ, if x≦x′, then f(x)≦f(x′).

Definition for a contraction: Let X be a metric space, with metric d. If f maps X into X and if there is a constant c<1 such that d(f(x),f(y))≦cd(x,y) for all x,yεX, then f is said to be a contraction of X into X.

In accordance with yet another aspect, a third lemma can be provided. The following lemma is a strengthening of the contraction principle (in the case of increasing functions). Let f:Rⁿ [symbol] Rⁿ be a function that is increasing. Assume f is a contraction of Rⁿ under some metric. Then there exists one and only one x*εRⁿ such that f(x*)=x*. Furthermore, for every vector xεRⁿ satisfying x≧f(x), we have x≧x*. Similarly, for every vector xεRⁿ satisfying x≦f(x), we have x≦x*. To prove the third lemma, define a sequence x₁, x₂ . . . as follows: x₁=x, and xᵢ₊₁, =f(xᵢ) for every i≧1. Since f is increasing and x≧f(x), by induction we have xᵢ≧x for every i. Since f is a contraction, the distance between xᵢ and xᵢ₊₁, tends to zero and therefore this sequence must have a limit. Let x* be any such limit point. Since xᵢ≧x for all i, we have x*≧x. Also, since f is a contraction, it must be continuous, and therefore the limit of the sequence f(x₁), f(x₂), . . . is f(x*). But this is limit x*. Therefore, f(x*)=x*. Furthermore, if there is another x′ε [symbol] ⁿ such that f(x′)=x′, then we have d(x, x′)=d(f(x)−f(x′))≦cd(x,y), which is a contradiction. Hence, f has a unique fixed point x*≧x. The other part can be proved similarly.

It remains to show that φ satisfies the conditions of the above lemma, which can be illustrated by the following:

$$\begin{matrix}\vert {ϕ}_{i} ( x ) - {ϕ}_{i} ( y ) \vert = \vert {max}_{S ⊆ N} \{ {\sum }_{j ∈ S} {p}_{ij , S} ( {x}_{j} + {r}_{ij} ) \} - {max}_{S ⊆ N} \{ {\sum }_{j ∈ S} {p}_{ij , S} ( {y}_{j} + {r}_{ij} ) \} \vert \geq \\ {max}_{S ⊆ N} \vert {\sum }_{j ∈ S} {p}_{ij , S} ( {x}_{j} + {r}_{ij} ) - \{ {\sum }_{j ∈ S} {p}_{ij , S} ( {y}_{j} + {r}_{ij} ) \} \vert \geq \\ {max}_{S ⊆ N} \{ {\sum }_{j ∈ S} {p}_{ij , S} \vert {x}_{j} - {y}_{j} \vert \} \leq {max}_{S ⊆ N} \{ {\sum }_{j ∈ S} {p}_{ij , S} D \} \leq ( 1 - δ ) D\end{matrix}$$

Therefore, ∥φ(x)−φ(y)∥_{∞}=maxᵢ|φᵢ(x)−φᵢy|≦(1−δ)D. Hence φ is a contraction.

In accordance another aspect, a fourth lemma can be employed. The fourth lemma provides that a function φ defined supra is increasing, and is a contraction of [symbol] ⁿ with respect to the metric l_{∞}. Accordingly, proof of the second lemma can now be supplied. Since the third and fourth lemmas imply that φ has a unique fixed point, it can be shown that this fixed point is R*. First, we show that R*≦φ(R*), because the first lemma provides that for every i, Rᵢ*=Σ_{jεδ}_{⁺}₍ᵢ₎p_{ij,S}(Rⱼ*+rᵢⱼ)≦φᵢ(R*), where δ⁺(i) denotes the set of vertices that have an edge from i in G*. The third and fourth lemmas indicate there must be a vector x*εRⁿ such that x*≧R* and x*=φ(x*). Now, we define Sᵢ:=argmax_{S⊂N}{Σ_{jεS}p_{ij,S}(xⱼ*+rᵢⱼ)}, and let the graph G′ be the directed graph with an edge from i to j if and only if jεSᵢ. The definition of G′ and the statement x*=φ(x*) imply that x* is a solution for the system of equations (1) for the graph G′, and therefore by the first lemma, xᵢ* is the expected revenue of a random walk starting from i in G′. However, since x*≧R* and R* is the optimal revenue, we must have x*=R* (here we are using the assumption that pᵢ>0 for all i). Therefore, φ(R*)=R*, completing the proof of the second lemma.

In accordance with yet another aspect, the iterative algorithm can now be provided. One idea of this algorithm is to start from the vector 0 and apply the function φ iteratively. It is readily apparent that this gives a sequence that converges to R*. It is shown that if this process stops after T steps, the resulting vector gives a graph (e.g., graph 140) that has revenue close to R*. The algorithm is presented in detail below.
Let Rᵢ⁰:=0 for every i.
   For t:=1 to T do
For every i, let Rᵢ^{t}:=max_{S⊂N {Σ}_{jεS}p_{ij,S}(Rⱼ^{t-1}+rᵢⱼ)}
For every i, let Sᵢ:=argmax_{S⊂N}{Σ_{jεS}p_{ij,S}(Rⱼ^{T}+rᵢⱼ)}
   Output the graph G̅ that has a link from i to j if and only if jεSᵢ.

In accordance with still another aspect of the claimed subject matter, a first theorem can be provided. Let Δₘₐₓ:=max_{i,j}rᵢⱼ and Δₘᵢₙ:=min_{i,j,S}p_{ij,S}rᵢⱼ, and ε>0 be given. Then the solution provided by the iterative algorithm after

$$T = O ( {δ}^{- 1} log ( \frac{{Δ}_{max}}{ɛ δ Δ min} ) )$$

iterations is within a 1+ε factor of the optimal revenue. Proof for the first theorem can be as follows: According to the fourth lemma above, the function f contracts the % distance by a factor of 1−δ. Therefore, by induction on t, we have ∥R^{t}−R^{t-1}∥_{∞≦(}1−δ)^{t-1}∥R¹∥_{∞}≦(1−δ)^{t}Δₘₐₓ. Let R* be the limit of R^{t} (note that even though the algorithm only defines R^{t} for t≦T, we can define this sequence beyond T), which by the second lemma gives the optimal revenue starting from each node. By the above inequality, we obtain ∥R^{t}−R*∥_{∞}≦(1−δ)^{t+1}δ⁻¹Δₘₐₓ.

It can also be shown that the graph G̅ has revenue close to optimal by applying the third lemma to the function Ψ: Rⁿ [symbol] Rⁿ defined as follows: for every i, Ψᵢ(x)=Σ_{jεS}_{ᵢ}p_{ij,S}_{ᵢ}(xⱼ+rᵢⱼ). The first lemma indicates the unique fixed point of Ψprovides the revenue for the graph G̅. Furthermore, it is easy to see that Ψ is also a contraction. Denote this fixed point as R̅, and let x:=R*/(1+ε) for some constant ε′>0 that will be fixed later.

Thus:

$$\begin{matrix}{ψ}_{i} ( x ) = {\sum }_{j ∈ {S}_{i}} {p}_{ij , {S}_{i}} ( \frac{{R}_{j}^{*}}{1 + {ɛ}^{′}} + {r}_{ij} ) \geq \\ {\sum }_{j ∈ {S}_{i}} {p}_{ij , {S}_{i}} ( \frac{{R}_{j}^{T} - {( 1 - δ )}^{T + 1} {δ}^{- 1} {Δ}_{max}}{1 + {ɛ}^{′}} + {r}_{ij} ) \geq \\ {\sum }_{j ∈ {S}_{i}} {p}_{ij , {S}_{i}} ( \frac{{R}_{j}^{T} + {r}_{ij}}{1 + {ɛ}^{′}} ) + \\ \frac{{ɛ}^{′} {\sum }_{j ∈ {S}_{i}} {p}_{ij , {S}_{i}} {r}_{ij} - {( 1 - δ )}^{T + 1} {δ}^{- 1} {Δ}_{max}}{1 + {ɛ}^{′}} \geq \\ \frac{{R}_{i}^{T + 1}}{1 + {ɛ}^{′}} + \frac{{ɛ}^{′} {Δ}_{min} - {( 1 - δ )}^{T + 1} {δ}^{- 1} {Δ}_{max}}{1 + {ɛ}^{′}}\end{matrix}$$

When examining ε′=(1−δ)^{T+1}δ⁻¹Δₘₐₓ/Δₘᵢₙ, the above inequality implies that

$${ψ}_{i} ( x ) \geq \frac{{R}_{i}^{T + 1}}{1 + {ɛ}^{′}} = {x}_{i}$$

for all i. Therefore, by the third lemma, the fixed point of Ψ, which is R̅, greater than or equal to x. Thus, R̅≧R*/(1+ε). Therefore, the revenue of G̅ after T steps is at most a factor of 1+ε′ away from the optimal revenue. Now, taking

$$T = O ( {δ}^{- 1} log ( \frac{{Δ}_{max}}{ɛ δ Δ min} ) ) ,$$

we obtain ε′<ε and the first theorem provided supra follows. It is to be appreciated that in some cases Δₘᵢₙ can be replaced at runtime of the algorithm by minᵢRᵢ*. As an addition to or alternative to the iterative algorithm described supra, an alternative algorithm (e.g., linear programming algorithm) is presented for (exactly) computing the revenue-maximizing hyperlink structure. For simplicity of presentation, techniques are described in the case of no externalities, however it is to be appreciated this need not be the case. The linear programming algorithm can first solve a linear program describing the optimal structure and then can proceed to round it. Since no factors need be lost in the rounding, the algorithm can compute an exact optimal solution.

One optimization question facing, e.g., a web designer in this setting is to find a sub-graph (e.g., graph 140) of the complete graph (e.g., graph 105) in which each node has degree at most kᵢ and the total revenue is maximized. This can be formulated as a mathematical program as follows. Let xᵢ be a variable representing the expected number of times a web surfer encounters node i and yᵢⱼ be an indicator variable for the existence of hyperlink ij. Thus, the expected number of times a web surfer traverses link ij is simply xᵢpᵢⱼyᵢⱼ. Relaxing the integrality constraint on yᵢⱼ, the problem then becomes:

$$\begin{matrix}max {\sum }_{i , j ∈ N} {r}_{ij} \cdot ( {x}_{i} {p}_{ij} {y}_{ij} ) & ( 2 ) \\ s . t . ∀ j ∈ N : {x}_{j} \leq {p}_{j} + {\sum }_{i ∈ N} {x}_{i} {p}_{ij} {y}_{ij} & ( 3 ) \\ ∀ i ∈ N : {\sum }_{j ∈ N} {y}_{ij} \leq {k}_{i} \\ ∀ i , j ∈ N : 0 \leq {y}_{ij} \leq 1 \\ ∀ i ∈ N : {x}_{i} \geq 0. & ( 4 )\end{matrix}$$

Constraint 3 encodes the “conservation of flow”: the expected number of times xⱼ a surfer visits node j can not be more than the expected number of times pⱼ he starts surfing from j plus the expected number of times Σ_{iεN}xᵢpᵢⱼyᵢⱼ that he enters j from a neighboring node. Constraint 4 encodes the out-degree constraint on a node i.

This mathematical program can be transformed to a linear program by performing the change of variables zᵢⱼ=xᵢyᵢⱼ. This provides the program

$$max {\sum }_{i , j ∈ N} {r}_{ij} {p}_{ij} {z}_{ij} \\ s . t . ∀ j ∈ N : {x}_{j} \geq {p}_{j} + {\sum }_{i ∈ N} {p}_{ij} {z}_{ij} \\ ∀ i ∈ N : {\sum }_{j ∈ N} {z}_{ij} \leq {k}_{i} {x}_{i} \\ ∀ i , j ∈ N : {z}_{ij} \leq {x}_{i} \\ ∀ i ∈ N : {x}_{i} \geq 0 \\ ∀ i , j ∈ N : {z}_{ij} \geq 0 , \qquad ( 5 )$$

which is linear in the variables xᵢ and zᵢⱼ. In the next section, it is shown how to round an optimal fractional solution (xᵢ, zᵢⱼ) to linear program equation (5) to a solution in which zᵢⱼ/xᵢε{0,1} for all i,jεN.

Consider an optimal fractional solution to equation (5). For all iεN such that xᵢ>0 and all jεN, define yᵢⱼ=zᵢⱼ/xᵢ. Notice if yᵢⱼε{0,1} for all i,jεN, then these yᵢⱼ can be used to define a feasible hyperlink structure with optimal revenue.

Otherwise, let G=(N,E) be a graph where edge ij exists if yᵢⱼ>0 and has transitional probability pᵢⱼyᵢⱼ. Consider an arbitrary node i₀εN with at least one fractional out-going edge, i.e. for at least one j, 0<yᵢ_{₀}ⱼ<1. Hence, this node can be “fixed” without sacrificing any of the total revenue.

Accordingly, a fifth lemma can be provided. For example, there is a graph G′ with total expected revenue equal to G in which i₀ has exactly kᵢ_{₀} integral out-links. Proof for the fifth lemma is as follows: the fractional out-links of i₀ in G are written as a convex combination of feasible integral out-links and show that one of these corresponding graphs has revenue at least that of G. As G is an optimal fractional graph, one may assume that Σⱼyᵢ_{₀}ⱼ=kᵢ_{₀}. Thus, the {yᵢ_{₀}ⱼ} lie in the integral polytope described by Σⱼyᵢ_{₀}ⱼ=kᵢ_{₀} and 0≦yᵢ_{₀}ⱼ≦1. Let Fₗε{0,1}^{|N|} be the vertices of this polytope, and note that each Fₗ has at most kᵢ_{₀} non-zero coordinates. We represent the {yᵢ_{₀}ⱼ} as a convex combination of these vertices ΣₗλₗFₗ where Σ_{lλ}ₗ=1.

Consider the graph Gₗ=(N, Eₗ) where i₀ only has links in Fₗ. In other words, Eₗ=E−{yᵢ_{₀}_{j}+{i}₀j:Fₗ(j)=1}. Let R′ₗ be the expected revenue that a random walk in Gₗ starting at i₀ collects before returning to i₀. Furthermore, let pₗ be the probability that a random walk in Gₗ starting at i₀ returns to i₀. If pₗ=1, then the total revenue in Gₗ is infinite and therefore optimal. Otherwise, the total expected revenue Rₗ of a random walk starting from i₀ in Gₗ is Rₗ=R′ₗ+pₗRₗ, and so:

$${R}_{l} = \frac{{R}_{l}^{′}}{1 - {p}_{l}} .$$

In order to prove that for some l, the revenue Rₗ of Gₗ is at least the total revenue of G, the total revenue R of G can be written in terms of Rₗ as follows: by linearity of expectation, the expected revenue that a random walk in G starting at i₀ collects before returning to i₀ is simply ΣₗλₗR′ₗ. Also, the probability of returning to i₀ is Σₗλₗpₗ. Therefore, R=ΣₗλₗR′ₗ+ΣₗλₗpₗR, and so:

$$R = \frac{{\sum }_{l} {λ}_{l} {R}_{l}^{′}}{1 - {\sum }_{l} {λ}_{l} {p}_{l}} .$$

Using the fact that Σₗλₗ=1, R an be re-written as

$$R = \frac{{\sum }_{l} {λ}_{l} {R}_{l}^{′}}{{\sum }_{l} {λ}_{l} ( 1 - {p}_{l} )} ,$$

where we restrict the summation to the vertices Fₗ such that λₗ>0. The fifth lemma then follows from the fact that (Σₗaₗ)/(Σₗbₗ)≦maxₗ(aₗ/bₗ) for any two sequences of positive real numbers {aₗ} and {bₗ} Proceeding now to “fix” iteratively all nodes i with fractional out-links to get an integral graph G with optimal revenue (e.g., graph 140).

It is to be understood and appreciated that the results provided above in the case of no externalities can be extended to the general case of extant externalities by using the following mathematical programming formulation. Let y_{i,S} be an indicator variable for the event that page i chooses to link to pages in S. As before, xᵢ represents the expected number of times a surfer visits page i. By convention, we define p_{ij,S}=0 for j∉S.

$$max {\sum }_{i , j ∈ N , S ⊆ N} {r}_{ij} \cdot ( {x}_{i} {p}_{ij , S} {y}_{i , S} ) \\ s . t . ∀ j ∈ N : {x}_{j} \leq {p}_{j} + {\sum }_{i ∈ N} {x}_{i} {p}_{ij , S} {y}_{i , S} \\ ∀ i ∈ N : {\sum }_{j ∈ N} {y}_{i , S} \leq 1 \\ ∀ i , j ∈ N : 0 \leq {y}_{i , S} \leq 1 \\ ∀ i ∈ N : {x}_{i} \geq 0. \qquad ( 6 )$$

Game Theoretic Questions

As detailed supra, graph 105 can represent a model of an entire website. In many situations, especially for large companies, it is often the case that subsets of the web pages constituting the entire website are controlled by distinct (and sometimes even competing) profit centers, each responsible for their own profit and loss account. Accordingly, it may not be reasonable to expect that a particular profit center, or group of profit centers, will comply with the optimal web site design (e.g., optimized graph 140) at it own expense. That is, while an optimized graph 140 may decidedly yield higher revenue for the entire website, the optimized graph 140 may not include hyperlinks (edges) of one particular profit center, therefore precluding potential revenue for that particular profit center. One approach to alleviate discord brought about by the competing interests is to divide the total revenue of the website among the profit centers to ensure stability. This implies that there is always a way to divide revenue among profit centers such that the optimal web site design (e.g., optimal graph 140) is stable in that each profit center can receive a total revenue at least as large as the revenue it would be able to extract as a coalition.

Since cooperative game theory studies games in which the primitives are actions taken by coalitions of players, such a setting can be interpreted as a cooperative game where the nodes of the graph 105 are the players. Thus, each web page is owned by an individual self-motivated agent such as a profit center within a company. This individual agent seeks hyperlinks that maximize its revenue, but may cooperate with other agents in doing so and thereby capitalize on the induced externalities between links. As such, the game can be considered both in transferable and non-transferable utility settings. In a transferable utility setting, the value generated by a coalition may be distributed in an arbitrary manner among the members of the coalition whereas in a not-transferable utility setting, each node in a coalition receives only the revenue it generates.

Cooperative Game with Transferable Utility (TU)

In a TU game, one underlying assumption is that the revenue generated by a coalition may be shared among its members in any manner. A TU game is defined by a value function v, which assigns to every possible coalition of players the value they can achieve. The value v(S) of subset S of nodes can be the value of the corresponding linear program equation (5) detailed above with variables restricted to the set S. It is known that relevant stable solutions of the game are in the core. A solution is in the core of a coalition game with TU if for all coalitions S, Σ_{iεS}ξᵢ≧v(S). Thus, the core is described by a set of linear inequalities. Hence, a set of payoffs ξᵢ is in the core if Σ_{iεN}ξᵢ=v(N) and for all S⊂N, Σ_{iεS}ξᵢ≧v(S). Proof that the game has a non-empty core is already known, however a standard proof based on linear programming duality is provided below. In order to write the dual of equation (5), variables αᵢ, βᵢi, and γᵢⱼ correspond to the first, second, and third inequality, respectively. The dual is then:

$$min {\sum }_{i ∈ N} {α}_{i} {p}_{i} \\ s . t . ∀ j ∈ N : {α}_{j} - {k}_{j} {β}_{j} - {\sum }_{i ∈ N} {γ}_{ij} \geq 0 \\ ∀ i , j ∈ N : - {α}_{j} {p}_{j} + {β}_{i} + {γ}_{ij} \geq {r}_{ij} {p}_{ij} \\ ∀ j ∈ N : {α}_{j} \geq 0 \\ ∀ i ∈ N : {β}_{i} \geq 0 \\ ∀ i , j ∈ N : {γ}_{ij} \geq 0. \qquad ( 7 )$$

Hence, the payoffs ξi=αᵢpᵢ are in the core. It is readily apparent that Σ_{iεN}ξᵢ=Σ_{iεN}αᵢpᵢ=v(N) by the linear programming duality. Moreover, to prove for all S⊂N. Σ_{iεS}ξᵢ≧v(S), it is only necessary to show that the optimal solution (αᵢ, βᵢ, γᵢⱼ) to equation (7) is a feasible solution to equation (7) restricted to players in S. This follows easily as the inequalities of equation (7) restricted to the players in S are a subset of those in equation (7). Therefore, the game has a non-empty core, and the solution can be found in polynomial time.

Cooperative Game with Nona-Tranesferable Utility (NTU)

Since TU games assume that the players are able to distribute the total revenue in any manner, it is to be appreciated that such an assumption is not always reasonable. For example, the performance of a profit center is often measured in terms of the amount of revenue it generates for the company, and there is no mechanism through which profit centers may share revenue prior to review. A NTU game can generalize TU games by studying situations such as these in which not all payoff vectors are feasible for a coalition.

A NTU game can consist of a set of N of players for each coalition N⊂S a set [symbol] (S)⊂ [symbol] ^{|S|} of feasible payoff vectors for that coalition. The sets [symbol] (S) are assumed to satisfy some mild assumptions, namely: 1) that [symbol] (S) is closed; 2) if vε [symbol] (S), then for all v′ [symbol] ^{|S|} with v′≦v (coordinate-wise), v′ε [symbol] (S); and 3) the set of vectors in [symbol] (S) in which each player receives at least the utility that player can achieve individually is a nonempty, bounded set. Intuitively, a solution to an NTU game with payoffs vε [symbol] (N) is stable (e.g., in the core) if no coalition S can withdraw and achieve a payoff vector v′ε [symbol] (S) such that each member of S improves his payoff. For notational convenience, v|_{S} can denote the vector [symbol] ^{|S|} whose coordinates are the coordinates of v restricted to the players in S. A vector vε [symbol] (N) is in the core of the NTU game if there is no coalition S and vector v′ε [symbol] (S) such that v′>v|_{S} (coordinate-wise). To consider the conditions under which an NTU game has a nonempty core, let λ_{S} be a fractional partition λ_{S} of players, e.g., a set of coefficients 0≦λ_{S}≦1 of subsets of N such that for all players i, Σ_{S:iεS}λ_{S}=1. An NTU game is called balanced if, for every fractional partition λ_{S}, a vector vε [symbol] ^{|N|} must be in [symbol] (N) if v|_{S} ε [symbol] (S) for all S with λ_{S}>0.

Accordingly, a second theorem can be provided that states a cooperative game with NTU has a nonempty core if and only if it is balanced. In the situation described above with competing profit centers, the set [symbol] (S) consists of the payoff vectors v where vᵢ is (at most) the revenue of i in some hyperlink structure on S. More formally, vε [symbol] (S) if and only if there is a (fractional graph G on nodes S such that for each player iεS, vᵢ is at most the expected revenue of i in G. Alternatively, this condition can be stated using program 2: vε [symbol] (S) if and only if there is a feasible solution (xᵢ,yᵢⱼ) to program 2 such that for each player iεS, vᵢ is at most Σⱼ·(xⱼ, pⱼᵢyⱼᵢ) (the expected revenue of i). These sets [symbol] (S) satisfy the assumptions stated above, and so the game is an NTU game.

In addition, a third theorem can be set forth that states there is a fractional graph in the core of the website game. Fractional graphs can be though of as the result of mixed strategies in hyperlink selection. In other words, if a node i is allowed to have fractional out-links of total weight at most kᵢ (or probabilistically select kᵢ links according to their fractional weight), then the core is nonempty. It should be appreciated that the efficient (e.g., revenue-maximizing) graph is in the TU core, this may not be the case for the NTU core. In fact, the solutions in the NTU core may be arbitrarily inefficient.

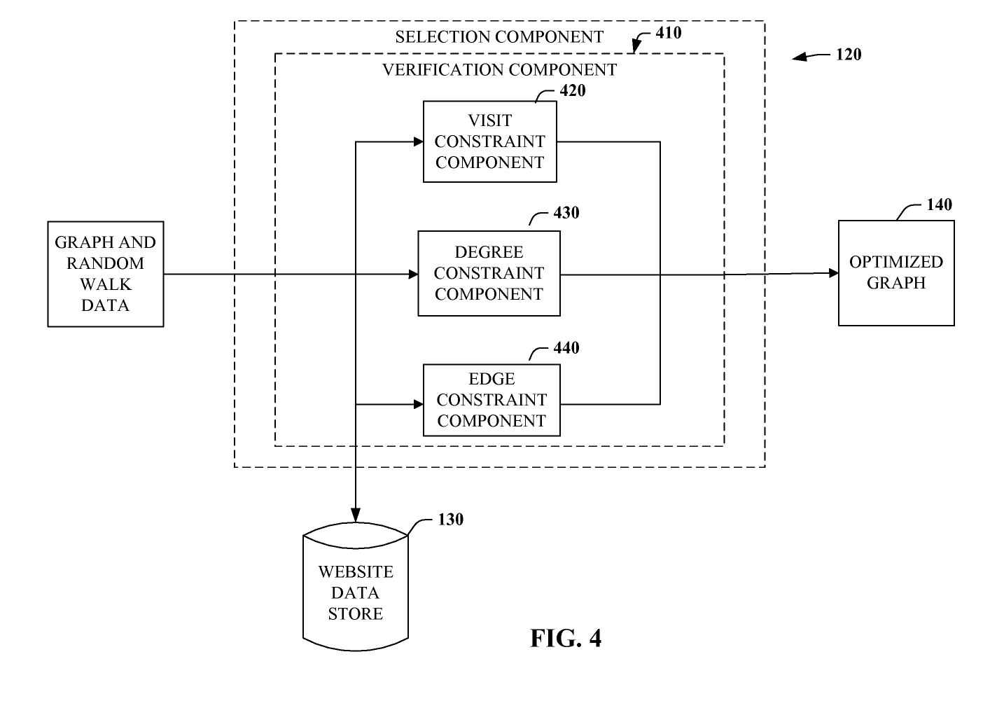

Turning to FIG. 4, the selection component 120 is illustrated in accordance with another aspect of the claimed subject matter. The selection component 120 can include a verification component 410 that ensures that constraints on the parameters of the system are within acceptable ranges. The verification component 410 can also include a visit constraint component 420 that applies a constraint to the number of times a particular node is visited. For instance, this can be expressed as:

$${x}_{j} \leq {p}_{j} + {\sum }_{i ∈ N} {x}_{i} {p}_{ij} {y}_{ij} ,$$

where xⱼ is the number of times a web page is accessed, which is less than pⱼ, the expected number of times the user starts from node j, plus the expected number of times Σ_{iεN}xᵢpᵢⱼyᵢⱼ that the user visits node j from a neighboring node; xᵢpᵢⱼyᵢⱼ is the expected number of times a web surfer traverses links ij,

xᵢ represents the expected number of times a web surfer encounters a node i,

pᵢⱼ represents the probability that a surfer on page i follows a hyperlink to page j, and

yᵢⱼ expresses the existence of an edge (hyperlink) between nodes i and j.

The verification component 410 can include a degree constraint component 430 that applies a constraint to the number of edges that are incident to a node i, which is to say that there is a limit on the number of hyperlinks on a given page. The component 430 can also constrain the variable yᵢⱼ to be less than the number of incident edges, kᵢ.

For example, the functionality of component 430 can be expressed as:

$$∀ i ∈ N : {\sum }_{j ∈ N} {y}_{ij} \leq {k}_{i} .$$

The verification component 410 can further include an edge constraint component 440, which constrains the variable yᵢⱼ. Because yᵢⱼ expresses the existence of an edge between nodes i and j, the expression ∀i,jεN: 0≧yᵢⱼ≦1 should hold true when determining the revenue maximizing random walk through the graph 105. Relaxing the constraint on yᵢⱼ, such that the value of yᵢⱼ is not limited to {0, 1} allows the selection component 110 to generate the optimal sub-graph (i.e. random walk that generates the maximum revenue) through the graph 105 received by the computation component 110. The relaxation of this constraint allows 0<yᵢ_{₀}ⱼ<1, which expresses that there is a “fractional edge” between two nodes of the graph 105. However, adjusting the value of yᵢⱼ such that ∀i,jεN,yᵢⱼε{0,1} still produces the optimal sub-graph within the graph 105 that maximizes revenue. Although this adjustment changes the value of yᵢⱼ, it can be shown that modifying the nodes for which there exists fractional edges does not adversely affect the maximum revenue generated over the graph 105.

It should be appreciated that the constraint values applied can either be generated by the components 420, 430, and 440 according to inputs or retrieved from the data store 130, which is coupled to the components 420, 430, and 440. Additionally, it is contemplated that in an embodiment of the present invention, the systems presented supra can be applied to subsets of the larger graph 105 so that the maximum revenue sub-graph can be solved for subsets of the links. Such an approach would be advantageous if the system were to dynamically generate links for individual web pages based on the demographics of a user browsing the web page for example. As a result, the maximum revenue sub-graph for a particular user could be determined and used to display links between web pages in order to provide the most relevant and useful information to the user. By utilizing a subset of the links, the aforementioned architecture is able to utilize those links that are considered to be relevant to a particular user based on known or inferred characteristics or preferences.

The aforementioned systems have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component providing aggregate functionality. The components may also interact with one or more other components not specifically described herein for the sake of brevity, but known by those of skill in the art.

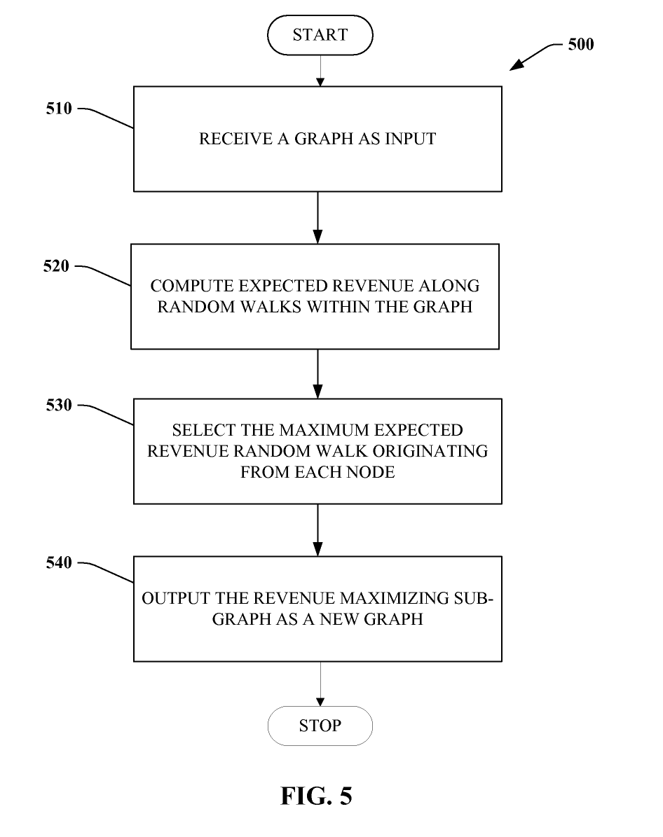

In view of the exemplary systems described supra, methodologies that may be implemented in accordance with the disclosed subject matter will be better appreciated with reference to the flow charts of FIGS. 5-8. While for purposes of simplicity of explanation, the methodologies are shown and described as a series of acts, it is to be understood and appreciated that the claimed subject matter is not limited by the order of the acts, as some acts may occur in different orders and/or concurrently with other acts from what is depicted and described herein. Moreover, not all illustrated acts may be required to implement the methodologies described hereinafter.

Turning to FIG. 5, a method of website optimization 500 is depicted. At 510, a directed graph corresponding to a website, wherein the nodes of the graph represent individual web pages and the edges correspond to possible hyperlinks between said web pages, is received as an input. At 520, the revenue of random walks through the graph can be computed in accordance with the probability and expected revenue associated with each edge of the graph, and the random walk through the graph can be constructed over a series of acts that add an additional edge with each iteration.

At 530, maximum revenue random walks originating from nodes of the directed graph are determined. This determination is a maximization problem where the probability that an edge exists in the graph and the expected revenue along a pre-existing walk allows the extension of the walk to create a new maximum expected revenue walk originating from a specified node. It should be mentioned that this problem applies to each of the nodes within the graph, and the determination of the maximum expected revenue random walk can be made iteratively for each node. At 540, the maximum expected revenue random walks through the graph, which represent a sub-graph of the original graph, are output such that nodes and edges of the sub-graph correspond to the revenue maximizing random walk through the original graph.

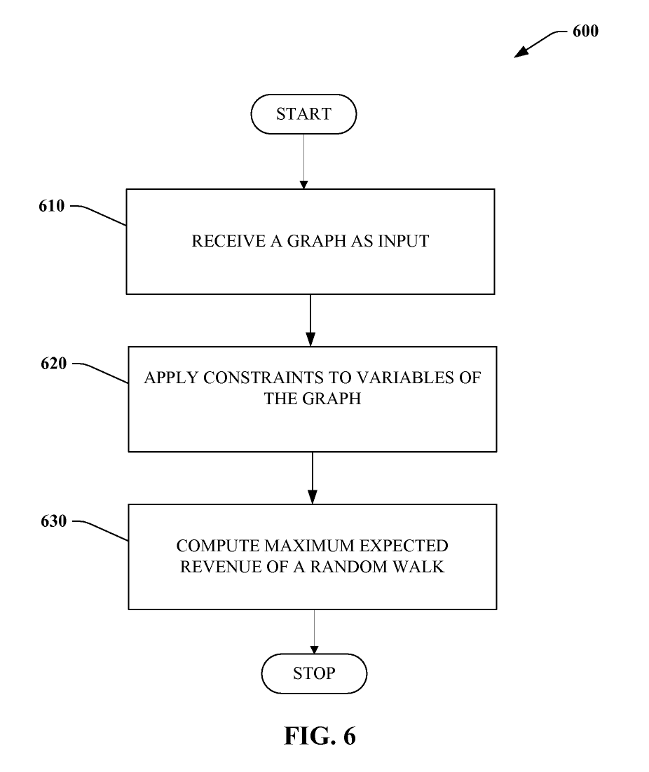

FIG. 6 is a representative flow diagram of a revenue maximization method. At 610, a graph corresponding to a website is received. The nodes of the graph correspond to individual web pages of the web site, and edges of the graph correspond to possible hyperlinks there between. The probability associated with each edge of the graph represents the probability that the edge exists between two nodes of the graph, and the expected revenue of an edge corresponds to the revenue that is expected to be generated when a user visits one node via the edge from another node of the graph.

At 620, the variables corresponding to the expected revenue, number of times a node is visited along a random walk, the existence of an edge between two nodes, and the probability associated with a given edge are verified to ensure that they are within certain values. Expressed alternatively, the variables are subject to constraints that ensure that the values used to maximize the expected revenue along a random walk through the graph are feasible given the structure of the original graph.

At 630, the revenue of a random walk through the graph is computed, such that the summation of the expected revenues associated with the edges along the random walk represents the maximum expected revenue within the graph. The expected revenue associated with the identified sub-graph is computed using the expected revenue of a hyperlink, the number of times a node is visited, and the existence and probability of a given edge within the graph.

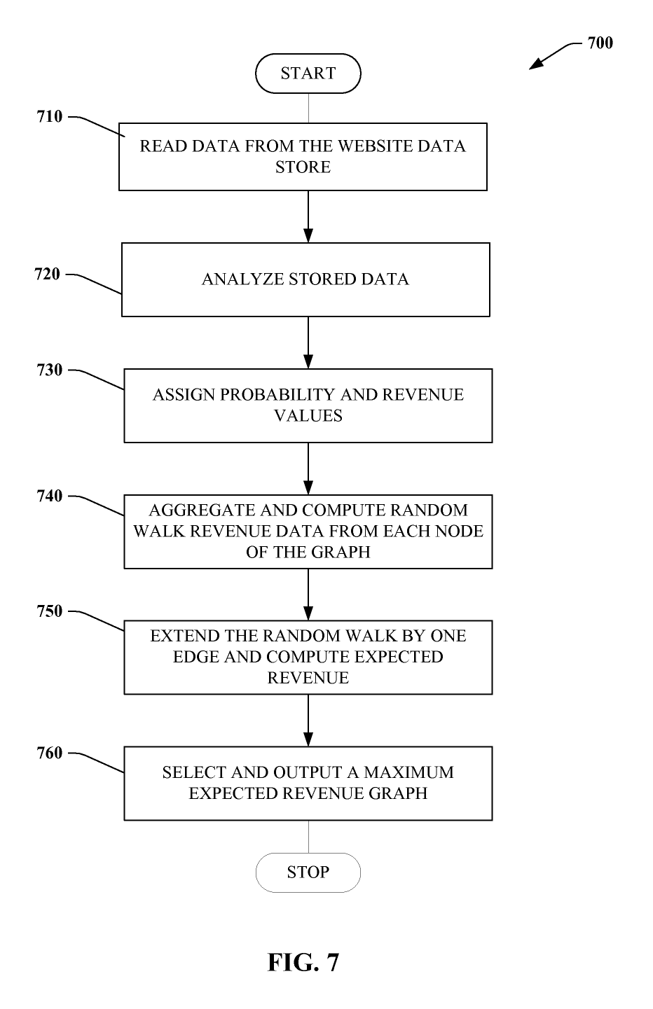

Turning to FIG. 7, a method of computing revenue over a random walk is depicted. At 710, data is read from a website data store so that the data can be used to determine variable values for the respective nodes and edges of a graph that is representative of a website. At 720, the stored data pertaining to the graph is analyzed along with data contained in the graph itself to determine how variable values should be assigned within the graph. The data being analyzed could correspond to stored revenue values for nodes or edges of the graph or probability values that indicate the likelihood with which a user will follow a given edge to a node.

At 730, probability and revenue values are assigned to corresponding nodes and edges within the graph. The values assigned to individual edges and nodes result from the analysis conducted on the stored data and any data contained in the graph itself. At 740, probability and revenue values assigned to individual nodes and edges of the graph are used to calculate revenue over random walks through the graph. An expected revenue value for a random walk originating from each node is computed by iterating through all the nodes of the graph. At 750, the random walk from each node is extended by one edge, which increases the expected revenue from each node of the graph along that random walk, and using the probability associated with each edge, the new expected revenue for a random walk from a specified node can be computed. At 760, the maximum expected revenue from each node along a given random walk can be selected, and the graph containing the random walks from each of the nodes of the original graph can be output.

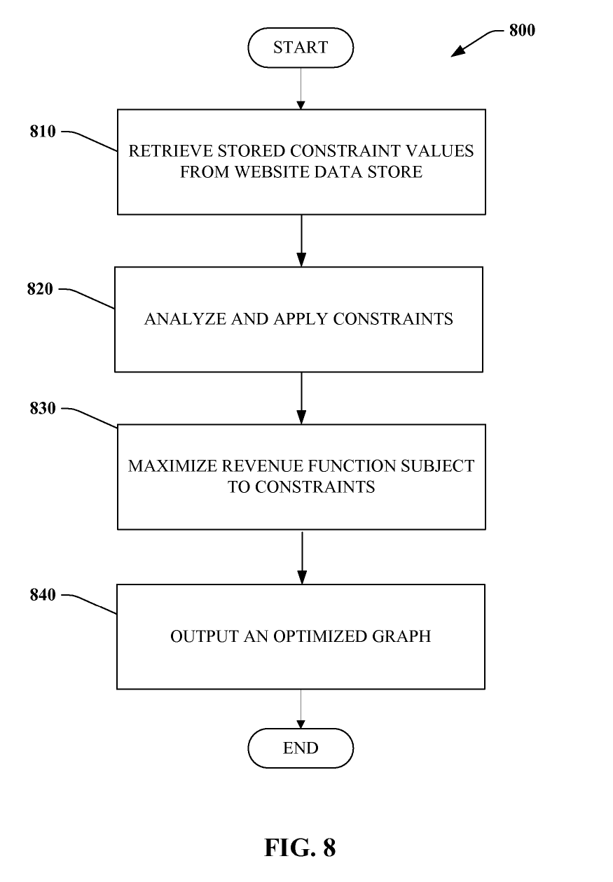

FIG. 8 is a representative flow diagram of a method for determining the maximum expected revenue of a random walk through a graph. At 810, stored constraint data is retrieved from a data store. The stored constraint data pertains to probabilities associated with each edge, the number of times a node can be visited, and expected revenue values associated with nodes and edges of a graph. At 820, the graph and the stored data are analyzed to determine the probabilities and expected revenue of each edge. The determined values can be associated with each of the edges and nodes within the graph so that the expected revenue of a random walk through the graph can be computed. At 830, the revenue function is maximized subject to the constraints on the variables of the graph. The revenue function calculates the expected revenue over a random walk through the graph by computing the expected revenue generated at each edge and node along the random walk in accordance with the number of times the node was visited, the probability that a user will follow an edge, and the expected revenue of the edge. At 840, the optimized sub-graph that generates the maximum expected revenue value through the original graph is output.

Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

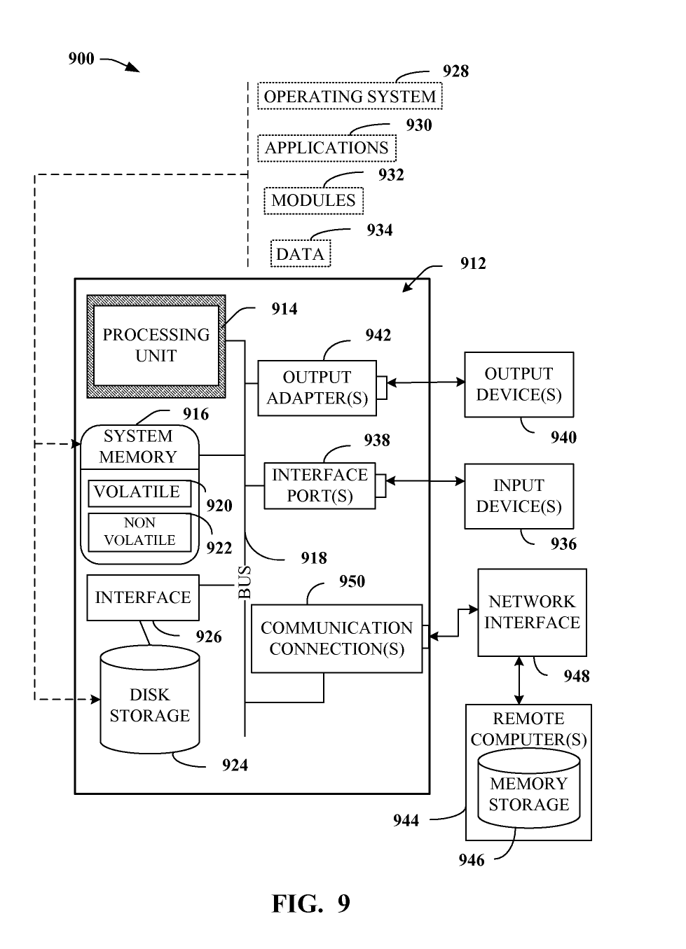

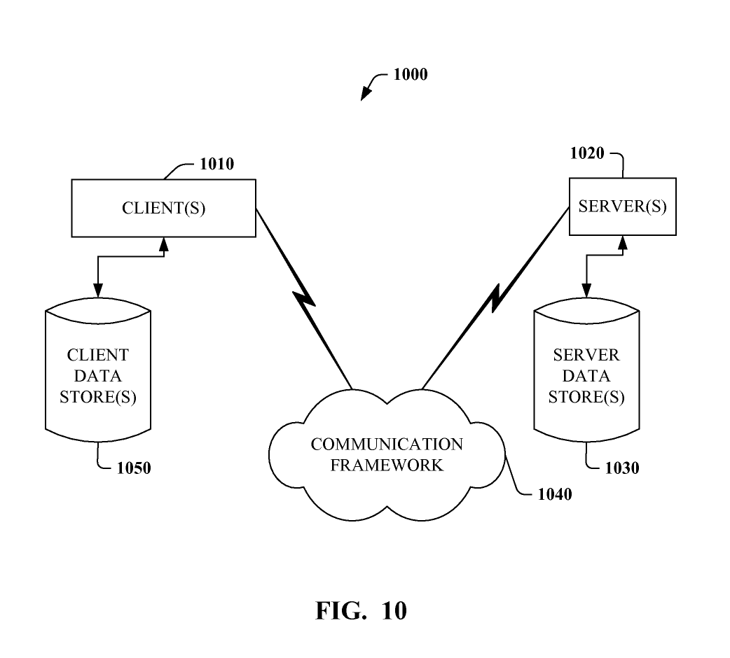

In order to provide a context for the various aspects of the disclosed subject matter, FIGS. 9 and 10 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed innovation can be practiced on stand-alone computers. In a distributed computing environment, program modules may be located in both local and remote memory storage devices.

With reference to FIG. 9, an exemplary environment 900 for implementing various aspects of the claimed subject matter includes a computer 912. The computer 912 includes a processing unit 914, a system memory 916, and a system bus 918. The system bus 918 couples system components including, but not limited to, the system memory 916 to the processing unit 914. The processing unit 914 can be any of various available processors. Dual microprocessors and other multiprocessor architectures also can be employed as the processing unit 914.

The system bus 918 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 916 includes volatile memory 920 and nonvolatile memory 922. The basic input/output system (BIOS), containing the basic routines to transfer information between elements within the computer 912, such as during start-up, is stored in nonvolatile memory 922. By way of illustration, and not limitation, nonvolatile memory 922 can include read only memory (ROM), programmable ROM (PROM), electrically programmable ROM (EPROM), electrically erasable programmable ROM (EEPROM), or flash memory. Volatile memory 920 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 912 also includes removable/non-removable, volatile/non-volatile computer storage media. FIG. 9 illustrates, for example a disk storage 924. Disk storage 924 includes, but is not limited to, devices like a magnetic disk drive, floppy disk drive, tape drive, Jaz drive, Zip drive, LS-100 drive, flash memory card, or memory stick. In addition, disk storage 924 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 924 to the system bus 918, a removable or non-removable interface is typically used such as interface 926.

It is to be appreciated that FIG. 9 describes software that acts as an intermediary between users and the basic computer resources described in the suitable operating environment 900. Such software includes an operating system 928. Operating system 928, which can be stored on disk storage 924, acts to control and allocate resources of the computer system 912. System applications 930 take advantage of the management of resources by operating system 928 through program modules 932 and program data 934 stored either in system memory 916 or on disk storage 924. It is to be appreciated that the claimed subject matter can be implemented with various operating systems or combinations of operating systems. A user enters commands or information into the computer 912 through input device(s) 936. Input devices 936 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 914 through the system bus 918 via interface port(s) 938. Interface port(s) 938 include, for example, a serial port, a parallel port, a game port, and a universal serial bus (USB). Output device(s) 940 use some of the same type of ports as input device(s) 936. Thus, for example, a USB port may be used to provide input to computer 912, and to output information from computer 912 to an output device 940. Output adapter 942 is provided to illustrate that there are some output devices 940 like monitors, speakers, and printers, among other output devices 940, which require special adapters. The output adapters 942 include, by way of illustration and not limitation, video and sound cards that provide a means of connection between the output device 940 and the system bus 918. It should be noted that other devices and/or systems of devices provide both input and output capabilities such as remote computer(s) 944.

Computer 912 can operate in a networked environment using logical connections to one or more remote computers, such as remote computer(s) 944. The remote computer(s) 944 can be a personal computer, a server, a router, a network PC, a workstation, a microprocessor based appliance, a peer device or other common network node and the like, and typically includes many or all of the elements described relative to computer 912. For purposes of brevity, only a memory storage device 946 is illustrated with remote computer(s) 944. Remote computer(s) 944 is logically connected to computer 912 through a network interface 948 and then physically connected via communication connection 950. Network interface 948 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 950 refers to the hardware/software employed to connect the network interface 948 to the bus 918. While communication connection 950 is shown for illustrative clarity inside computer 912, it can also be external to computer 912. The hardware/software necessary for connection to the network interface 948 includes, for exemplary purposes only, internal and external technologies such as, modems including regular telephone grade modems, cable modems and DSL modems, ISDN adapters, and Ethernet cards.

FIG. 10 is a schematic block diagram of a sample-computing environment 1300 with which the subject innovation can interact. The system 1000 includes one or more client(s) 1010. The client(s) 1010 can be hardware and/or software (e.g., threads, processes, computing devices). The system 1000 also includes one or more server(s) 1030. Thus, system 1000 can correspond to a two-tier client server model or a multi-tier model (e.g., client, middle tier server, data server), amongst other models. The server(s) 1030 can also be hardware and/or software (e.g., threads, processes, computing devices). The servers 1030 can house threads to perform transformations by employing the subject innovation, for example. One possible communication between a client 1010 and a server 1030 may be in the form of a data packet transmitted between two or more computer processes.

The system 1000 includes a communication framework 1050 that can be employed to facilitate communications between the client(s) 1010 and the server(s) 1030. The client(s) 1010 are operatively connected to one or more client data store(s) 1060 that can be employed to store information local to the client(s) 1010. Similarly, the server(s) 1030 are operatively connected to one or more server data store(s) 1040 that can be employed to store information local to the servers 1030.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has” or “having” or variations thereof are used in either the detailed description or the claims, such terms are intended to be inclusive in a manner similar to the term “comprising” as “comprising” is interpreted when employed as a transitional word in a claim.

What is claimed is:

1. A website optimization system, comprising:
a computation component that receives a directed graph representation of a website and computes expected revenue associated with a plurality of nodes and edges of the directed graph, the nodes represent web pages and the edges represent links to respective web pages; and
a selection component that identifies at least one revenue maximizing random walk associated with the nodes and edges and outputs a sub-graph of the directed graph that corresponds to a revenue maximizing random walk.

2. The system of claim 1, further comprising a probability component that assigns a probability to edge(s) between nodes.

3. The system of claim 1, further comprising a revenue component that assigns an expected revenue value to edge(s) between nodes.

4. The system of claim 1, further comprising an aggregation component that computes revenue of a random walk incrementally at nodes along the random walk.

5. The system of claim 1, the selection component includes a concatenation component that adds an additional edge to an existing random walk to create a new revenue maximizing random walk.

6. The system of claim 5, the selection component further comprises a comparison component that selects a random walk within the directed graph that generates maximum revenue from a specified originating node.

7. The system of claim 1, further comprising a verification component that constrains values of a plurality of variables.

8. The system of claim 7, further comprising a visit constraint component that constrains the variable expressing the expected number of times a specific node is visited.

9. The system of claim 7, further comprising a degree constraint component that constrains a variable expressing a degree of a node.

10. The system of claim 7, further comprising an edge constraint component that constrains a variable expressing existence of a hyperlink between two nodes.

11. The system of claim 1, the revenue maximizing random walk is a solution in a core based at least in part upon cooperative game theory.

12. The system of claim 11, the revenue maximizing random walk employs transferable utility.

13. The system of claim 11, the revenue maximizing random walk employs non-transferable utility.

14. A computer-implemented method for website optimization, comprising:
receiving a directed graph representation of a website, the directed graph comprises a plurality of nodes and edges, the nodes representing web pages and the edges representing links to respective web pages, and revenue values are associated with the respective nodes and/or edges;
computing expected revenue of random walks among the nodes and edges; and
generating a sub-graph of the directed graph that comprises at least one revenue-maximizing random walk.

15. The method of claim 14, the computing expected revenue of random walks comprises:
iterating through the plurality of nodes of the directed graph;
performing T steps for each node; and
adding one edge to the walk at least one of the respective T steps.

16. The method of claim 14, further comprising computing the revenue (R) of random walks with the following equation:
Rᵢ^{t}:=max_{S⊂N}{Σ_{jεS}p_{ij,S}(Rⱼ^{t-1}+rᵢⱼ)}
where:
i and j are nodes in the graph,
N is the set of nodes in the graph,
S is a subset of N, such that all the nodes jεS if i contains a hyperlink to page j,
rᵢⱼ is a revenue value representing expected revenue value from a web user following a hyperlink from page i to page j,
t represents the number of steps of the random walk,
p_{ij,S} is the sum of the revenue values.

17. The method of claim 14, the generating at least one revenue-maximizing random walk comprises:
iterating through the plurality of nodes of the graph; and
extending an existing random walk of T steps by one edge to increase maximum revenue for each node.

18. The method of claim 17, further comprising selecting the revenue maximizing random walk from each node i such that for every i, let Sᵢ:=argmax_{S⊂N}{Σ_{jεS}p_{ij,S}(Rⱼ^{T}+rᵢⱼ)}.

19. A computer-implemented system for website optimization, comprising:
means for receiving a directed graph representative of the website comprising nodes and edges the nodes represent web pages and the edges represent hyperlinks to respective web pages, and revenue values are associated with the respective nodes and/or edges;
means for computing revenue of random walks through the directed graph;
means for verifying a plurality of constraints; and
means for outputting a sub-graph comprising at least one revenue maximizing random walk associated with the nodes and edges.

20. The system of claim 19, further comprising means for computing the revenue of random walks using the following equation:
$$max {\sum }_{i , j ∈ N} {r}_{ij} \cdot ( {x}_{i} {p}_{ij} {y}_{ij} ) .$$
where xᵢpᵢⱼyᵢⱼ is the expected number of times a web surfer traverses links ij,
xᵢ represents the expected number of times a web surfer encounters a node i,
pᵢⱼ represents the probability that a surfer on page i follows a hyperlink to page j,
yᵢⱼ expresses the existence of an edge between nodes i and j.
